(19) United States
(12) Patent Application Publication
(10) Pub. No.: US 2026/0129032 A1
(43) Pub. Date: May 7, 2026

(54) FAULT TOLERANT CIPHER PROCESSING UTILIZING CRYPTOGRAPHIC CONTROLS

(71) Applicant: Rockwell Collins, Inc., Cedar Rapids, IA (US)

(72) Inventors: Reginald D. Bean, Center Point, IA (US); Joseph T. Constant, Marion, IA (US)

(21) Appl. No.: 19/345,789

(22) Filed: Sep. 30, 2025

Related U.S. Application Data
(60) Provisional application No. 63/715,978, filed on Nov. 4, 2024.

(51) Int. Cl. H04L 9/40; H04L 9/06; H04L 9/08

(52) U.S. Cl. CPC H04L 63/0428; H04L 9/0618; H04L 9/0869

(57) ABSTRACT

A system may include a first cipher engine, a second cipher engine, and a plaintext compare engine, wherein the first cipher engine, the second cipher engine, and the plaintext compare engine are configured to receive copies of an outbound data packet, wherein the first cipher engine and the second cipher engine are configured to encrypt the outbound data packet via at least one security policy, generating a first ciphertext data packet and a second ciphertext data packet. The system may include a set of first random number generators (RNGs) configured to generate a set of one-time pads. The system may include a set of front-end logic gates configured to encrypt the first ciphertext data packet according to the set of one-time pads. A system may include a hold register and a set of back-end logic gates configured to decrypt the first ciphertext data according to the set of one-time-pads.

### CROSS-REFERENCE TO RELATED APPLICATIONS

The present application claims the benefit of U.S. Provisional Patent Application No. 63/715,978 filed Nov. 4, 2024, titled “FAULT TOLERANT CIPHER PROCESSING UTILIZING CRYPTOGRAPHIC CONTROLS”, which is incorporated herein by reference in the entirety.

### TECHNICAL FIELD

The subject matter disclosed by the instant application is directed generally to cryptographic systems and more particularly to the fault-tolerant cryptographic systems.

### BACKGROUND

Traditional cipher engines that perform encryption and decryption for communication systems are susceptible to single faults that can cause the cipher engine to leak information. A leak occurs when plaintext information inadvertently arrives at the cipher text output of the cipher engine, resulting in the release of information that should have been encrypted but was not. Therefore, there is a need for systems and methods to prevent the release of non-encrypted information when a fault occurs.

### SUMMARY

In some embodiments, the techniques described herein relate to a fault tolerant cryptographic control system, including: a first cipher engine, a second cipher engine, and a plaintext compare engine, wherein the first cipher engine, the second cipher engine, and the plaintext compare engine are configured to receive copies of an outbound data packet, wherein the first cipher engine and the second cipher engine are configured to encrypt the outbound data packet via at least one security policy, generating a first ciphertext data packet and a second ciphertext data packet; a first random number generator (RNG) configured to generate a first one-time pad; a second RNG configured to generate at least one second one-time pad; a third RNG configured to generate a third one-time pad; a first front-end logic gate configured to encrypt the first ciphertext data packet according to the first one-time pad; a second front-end logic gate configured to double encrypt the first ciphertext data packet according to the at least one second one-time pad; a third front-end logic gate configured to triple encrypt the first ciphertext data packet according to an at least one third one-time pad; and a hold register configured to store at least one third encrypted ciphertext data packet.

In some embodiments, the techniques described herein relate to a fault tolerant cryptographic control system, wherein the first ciphertext data packet and the second ciphertext data packet are inspected via a first compare engine according to the at least one security policy, wherein the first ciphertext data packet and the second ciphertext data packet are inspected via an second compare engine according to the at least one security policy, wherein the outbound data packet and the second ciphertext data packet are inspected by the plaintext compare engine, wherein a successful comparison of the first ciphertext data packet and the second ciphertext data packet by the first compare engine is indicated by 1) transmitting a first release signal to the hold register and 2) transmitting the first one-time pad to a first back-end logic gate, wherein successful comparison of the first ciphertext data packet and the second ciphertext data packet by the second compare engine is indicated by 1) transmitting at least one second release signal to the hold register and 2) transmitting the at least one second one-time pad to a second back-end logic gate, wherein a successful comparison of the outbound data packet and the second ciphertext data packet by the plaintext compare engine is indicated by; 1) transmitting at least one third release signal to the hold register and 2) transmitting the at least one third one-time pad to at least one third back-end logic gate, wherein the hold register is configured to release the at least one third encrypted ciphertext data packet to the first back-end logic gate when the hold register has received the first release signal, the at least one second release signal, and the at least one third release signal.

In some embodiments, the techniques described herein relate to a fault tolerant cryptographic control system, further including: the first back-end logic gate, wherein the first back-end logic gate is configured to partially decrypt the at least one third encrypted ciphertext data packet according to the first one-time pad; the second back-end logic gate, wherein the second back-end logic gate is configured to partially decrypt the double encrypted ciphertext data packet according to the at least one second one-time pad; and the third back-end logic gate, wherein the third back-end logic gate is configured to fully decrypt the partially decrypted ciphertext data packet according to the third one-time pad.

In some embodiments, the techniques described herein relate to a fault tolerant cryptographic control system, wherein the first front-end logic gate, the at least one second front-end logic gate, the first back-end logic gate, and the at least one second back-end logic gate include at least one bitwise exclusive-or (XOR) logic gate.

In some embodiments, the techniques described herein relate to a fault tolerant cryptographic control system, wherein a fault of the first cipher engine prevents the first cipher engine from generating a first ciphertext data packet, wherein preventing the first cipher engine from generating a first ciphertext data packet causes the first compare engine and the second compare engine to halt operation and prevents the first ciphertext data packet from being released from the hold register.

In some embodiments, the techniques described herein relate to a fault tolerant cryptographic control system, wherein a fault of the first cipher engine prevents the second cipher engine from generating a second ciphertext data packet, wherein preventing the second cipher engine from generating a second ciphertext data packet causes the first compare engine and the second compare engine to halt operation and prevents the first ciphertext data packet from being released from the hold register.

In some embodiments, the techniques described herein relate to a fault tolerant cryptographic control system, wherein a fault one or more RNGs causes a generation of poor quality random numbers, wherein the generation of poor quality random numbers does not prevent encryption of the generating a first ciphertext data packet by the first cipher engine, and does not prevent the first ciphertext data packet from being received by a ciphertext output port.

In some embodiments, the techniques described herein relate to a fault tolerant cryptographic control system, wherein a fault in the first compare engine causes a mis-comparison between the first ciphertext data packet and the second first ciphertext data packet, wherein a mis-comparison between the first ciphertext data packet and the second first ciphertext data packet prevents the first ciphertext data packet from being released from the hold register.

In some embodiments, the techniques described herein relate to a fault tolerant cryptographic control system, wherein a fault in the second compare engine causes a mis-comparison between the first ciphertext data packet and the second first ciphertext data packet, wherein a mis-comparison between the first ciphertext data packet and the second first ciphertext data packet prevents the first ciphertext data packet from being released from the hold register.

In some embodiments, the techniques described herein relate to a fault tolerant cryptographic control system, wherein a fault in the hold register causes a premature release of first ciphertext data packet, wherein a premature release of the first ciphertext data packet causes first ciphertext data packets received by a ciphertext output port that are encrypted by the first cipher engine.

In some embodiments, the techniques described herein relate to a fault tolerant cryptographic control system, wherein a fault in one or more logic gates causes first ciphertext data packets received by a ciphertext output port that are encrypted by the first cipher engine.

In some embodiments, the techniques described herein relate to a fault tolerant cryptographic control system, wherein a failure of both the first cipher engine and the second cipher engine causes the plaintext compare engine to halt operation, wherein causing the plaintext compare engine to halt operation prevents the first ciphertext data packet from being released from the hold register.

In some embodiments, the techniques described herein relate to a fault tolerant cryptographic control system, wherein upon a failure of at least two of the first compare engine, the second compare engine, and the plaintext compare engine prevents the first ciphertext data packet from being released from the hold register.

In some embodiments, the techniques described herein relate to a fault tolerant cryptographic control system, wherein a fault of 1) the first cipher engine or the second cipher engine and 2) one or more of the first compare engine, the second compare engine, and the plaintext compare engine prevents the first ciphertext data packet from being released from the hold register.

In some embodiments, the techniques described herein relate to a method for cross-domain comparison with fault tolerant cryptographic control including: transmitting copies of an outbound data packet from a first domain to a first cipher engine, a second cipher engine, and a plaintext compare engine; encrypting the outbound data packet via the first cipher engine, the encryption creating a first ciphertext data packet; encrypting the outbound data packet via the second cipher engine, the encryption creating a second ciphertext data packet; generating a first one-time pad via a first random number generator (RNG); transmitting the first one-time pad to a first front-end logic gate and a first compare engine; generating at least one second one-time pad via at least one second RNG; transmitting the at least one second one-time pad to at least one second front-end logic gate and at least one second compare engine; single encrypting the first ciphertext data packet via the first front-end logic gate according to the first one-time pad; double encrypting the first ciphertext data packet via the at least one second front-end logic gate according to the at least one second one-time pad; triple encrypting the first ciphertext data packet via at least one third front-end logic gate according to an at least one third one-time pad; storing the at least one third encrypted ciphertext data packet within a hold register; comparing, via the first compare engine the first ciphertext data packet and the second ciphertext data packet according to at least one security policy; comparing, via the at least one second compare engine, the first ciphertext data packet and the second ciphertext data packet according to the at least one security policy; comparing, via the plaintext compare engine, the outbound data packet and the second ciphertext data packet; indicating a successful comparison of the first ciphertext data packet and the second ciphertext data packet by the first compare engine by 1) transmitting a first release signal to the hold register and 2) transmitting the first one-time pad to a first back-end logic gate; indicating a successful comparison of the first ciphertext data packet and the second ciphertext data packet by the at least one second compare engine by 1) transmitting at least one second release signal to the hold register and 2) transmitting the at least one second one-time pad to the at least one second back-end logic gate; indicating a successful comparison of the outbound data packet and the second ciphertext data packet by the plaintext compare engine by; 1) transmitting at least one third release signal to the hold register and 2) transmitting the at least one third one-time pad to at least one third back-end logic gate; when the hold register has received the first release signal, the at least one second release signal, and the at least one third release signal, releasing the at least one third encrypted ciphertext data packet to the first back-end logic gate; partially decrypting the at least one third encrypted ciphertext data packet via the first back-end logic gate according to the first one-time pad; partially decrypting the at least one double encrypted ciphertext data packet via the second back-end logic gate according to the second one-time pad; fully decrypting the at least one partially decrypted ciphertext data packet via the at least one third back-end logic gate according to the at least one third one-time pad; and transmitting from the at least one third back-end logic gate the at least one fully decrypted ciphertext data packet.

In some embodiments, the techniques described herein relate to a method, wherein the first front-end logic gate, the at least one second front-end logic gate, the first back-end logic gate, and the at least one second back-end logic gate include at least one bitwise exclusive-or (XOR) logic gate.

In some embodiments, the techniques described herein relate to a method, wherein a fault of the first cipher engine prevents the first cipher engine from generating a first ciphertext data packet, wherein preventing the first cipher engine from generating a first ciphertext data packet causes the first compare engine and the second compare engine to halt operation and prevents the first ciphertext data packet from being released from the hold register.

In some embodiments, the techniques described herein relate to a method, wherein a fault of the first cipher engine prevents the second cipher engine from generating a second ciphertext data packet, wherein preventing the second cipher engine from generating a second ciphertext data packet causes the first compare engine and the second compare engine to halt operation and prevents the first ciphertext data packet from being released from the hold register.

In some embodiments, the techniques described herein relate to a method, wherein a fault one or more RNGs causes a generation of poor quality random numbers, wherein the generation of poor quality random numbers does not prevent encryption of the generating a first ciphertext data packet by the first cipher engine, and does not prevent the first ciphertext data packet from being received by a ciphertext output port.

In some embodiments, the techniques described herein relate to a method, wherein a fault in the first compare engine causes a mis-comparison between the first ciphertext data packet and the second first ciphertext data packet, wherein a mis-comparison between the first ciphertext data packet and the second first ciphertext data packet prevents the first ciphertext data packet from being released from the hold register.

In some embodiments, the techniques described herein relate to a method, wherein a successful comparison of the plaintext input data packet to the second ciphertext data packet is a determination that the plaintext input data packet and the second ciphertext data packet are not equal.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims.

FIG. 1A is a block diagram of a generalized scheme for encrypting plaintext data, according to example embodiments of this disclosure.

FIG. 1B is a block diagram illustrating a fault tolerant cryptographic control system.

FIG. 2 is a block diagram illustrating a cross-domain cryptographic system.

FIG. 3 is a block diagram illustrating a cross-domain cryptographic system.

FIG. 4 is a block diagram illustrating the fault tolerant cryptographic control system of FIG. 1A, according to example embodiments of this disclosure.

FIGS. 5A through 5C are flow diagrams illustrating a method for parallel cross-domain inspection with sequential cryptographic control according to example embodiments of this disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein, a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

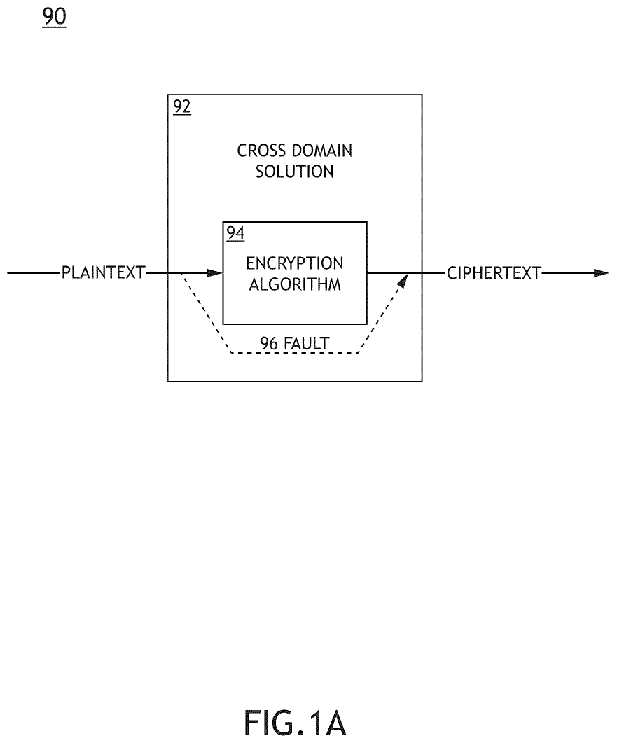

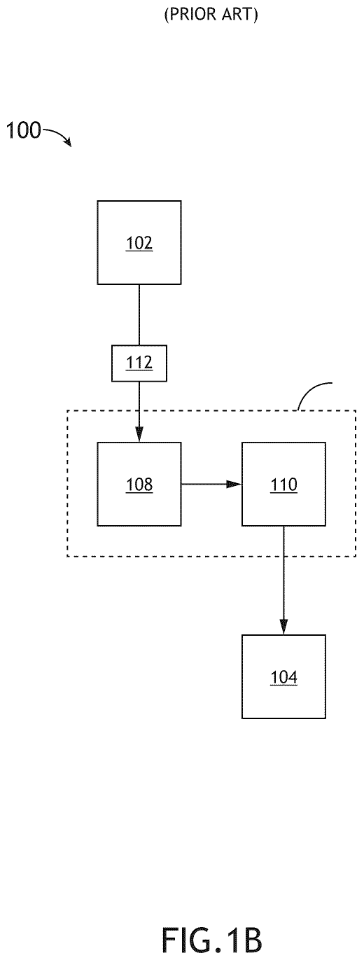

Broadly speaking, embodiments of the inventive concepts disclosed herein are broadly directed to systems and methods of a cross-domain solutions and fault tolerant cryptographic control systems for ensuring proper encryption and decryption of sensitive communications that include plaintext data from a first domain to a second domain. The system and methods utilize a functional architecture with cryptographic controls to establish fault tolerance, as opposed to specific design element redundancy and monitors to establish fault tolerance. These cryptographic controls function to prevent single and/or dual faults from causing plaintext data to exfiltrate out of a ciphertext interface. FIGS. 1B, 2, and 3 describe architectures for cross-domain solutions, whereas, FIGS. 1A, 4, and 5A-C describe fault tolerant cryptographic control systems that share similar architectures to the cross-domain solutions.

A generalized scheme 90 for encrypting plaintext data is shown in FIG. 1A, in accordance with one or more embodiments of the disclosure. Here, plaintext is received by a fault tolerant cryptographic control system 92. The cross-domain solution 106 is intended to ensure that plaintext transmitted from a transmitting domain is properly received as ciphertext by the receiving domain. The plaintext is encrypted into ciphertext via one or more encryption algorithms 94. In some instances, the encryption of the plaintext is disrupted by a fault 96 occurring within the fault tolerant cryptographic control system cross-domain solution 106, resulting in the plaintext not effectively encrypted into ciphertext. For example, the fault 96 could lead to plaintext being received by the receiving domain in an unencrypted state.

In embodiments, the fault tolerant cryptographic control system 92 provides for the secure transfer of data between different domains of a processing environment having multiple independent levels of security (MILS), e.g., differing security classification levels. Such a fault tolerant cryptographic control system cross-domain solution 106 provides the necessary redundancy without adding latency to the system.

Referring to FIG. 1B, a MILS processing environment 100 is shown, in accordance with one or more embodiments of the disclosure. The MILS processing environment 100 may include a first processing domain 102, a second processing domain 104, and a cross-domain solution 106 having guard engines 108, 110. We note that a MILS processing environment is disclosed in U.S. Pat. No. 11,296,876, filed on Sep. 11, 2020, which is incorporated by reference in its entirety.

In embodiments, the first domain 102 and the second domain 104 may have significantly different (e.g., and/or mutually incompatible) security classification levels and/or security policies. Conventional cross-domain solutions may achieve certifiability by providing both redundancy and non-bypassability (e.g., any data traveling between the first domain 102 and the second domain 104 cannot bypass the cross-domain solution 106). One way of achieving both objectives is sequential processing, whereby the guard engines 108 and 110 are dissimilar guard engines. For example, the first guard engine 108 (e.g., primary guard engine) may analyze an outbound data packet (112; e.g., in transit between the first domain 102 and the second domain 104) against one or more policies and, should the data packet be found passable, passes the data packet to the second guard engine 110 (e.g., secondary guard engine), which also analyzes the data packet against one or more policies. Should the second guard engine 110 also find the data packet 112 passable, it will be passed along to the second domain 104.

In embodiments, the cross-domain solution 106 may achieve the redundancy and non-bypassability of the conventional approach described above, but without the processing latency associated with sequential processing. For example, the first domain 102 and the second domain 104 may represent any two physical devices or components within the MILS environment 100, or any two virtual components (e.g., if the MILS environment 100 is a multi-core processing environment virtualized by a hypervisor and/or operating system). The guard engines 108, 110 of the cross-domain solution 106 may be redundant guard engines, or they may be dissimilar guard engines configured for data analysis (e.g., of data packets 112 in transit between the first domain 102 and the second domain 104) according to dissimilar policy sets. In embodiments, the cross-domain solution 106 preserves a redundant and non-bypassable path between the first domain 102 and the second domain 104 without the latency associated with sequential processing by configuring the guard engines 108, 110 in parallel while providing for sequential cryptographic controls.

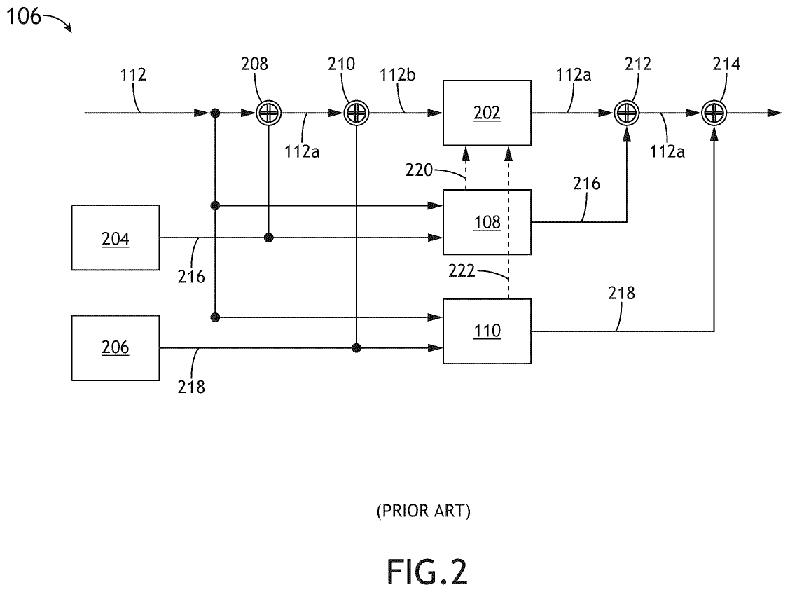

Referring now to FIG. 2 the cross-domain solution 106 is disclosed. The cross-domain solution 106 may include, in addition to the primary guard engine 108 and secondary guard engine 110, a hold register 202, random number generators 204, 206 (RNG), and logic gates 208, 210, 212, 214. We note that a cross-domain solution similar to FIG. 2 is disclosed in U.S. Pat. No. 11,296,876, filed on Sep. 11, 2020, which is incorporated by reference in its entirety.

In embodiments, the primary and secondary guard engines 108, 110 are connected in parallel between the first domain (102, FIG. 1) and the second domain (104, FIG. 1), while the logic gates 208-214 are connected in series, e.g., a first logic gate 208 and a second logic gate 210 between the first domain and the hold register 202 (e.g., first and second front-end logic gates), and a third logic gate 212 and a fourth logic gate 214 situated between the hold register and the second domain (e.g., first and second back-end logic gates). For example, the first RNG 204 and the second RNG 206 may each generate a unique random number (216, 218) (e.g., one-time pad) for double encryption of each data packet 112 in transit between the first domain 102 and the second domain 104.

In embodiments, the logic gates 208, 210, 212, 214 may be bitwise exclusive-or (XOR) logic gates or any like appropriate cryptographic modules. For example, the first logic gate 208 may encrypt the data packet 112 by computing an XOR of the incoming data packet 112 and the random number 216 received from the first RNG 204. The single-encrypted data packet (112a) may then be double-encrypted by the second logic gate in similar fashion computing an XOR using the random number 218 received from the second RNG 206. The double-encrypted data packet (112b) may then be stored by the hold register 202 until released by the guard engines 108, 110.

In embodiments, while the first and second logic gates 208, 210 may operate sequentially, the guard engines 108, 110 may operate in parallel. For example, the first guard engine 108 may receive a copy of the first random number 216 generated by the first RNG 204; similarly, the second guard engine 110 may receive a copy of the second random number 218 generated by the second RNG 206. The first guard engine 108 and the second guard engine 110 may inspect the data packet 112 in parallel. In some embodiments, the first guard engine 108 and the second guard engine 110 are redundant (e.g., protecting against a fault in either guard engine). In some embodiments, the first guard engine 108 and the second guard engine 110 are dissimilar (e.g., protecting against latent defects or bugs that may not be detectable by the other guard engine).

In embodiments, when the first guard engine 108 approves the data packet 112 for transfer to the second domain 104, the first guard engine may transmit a release signal (220; e.g., release strobe) to the hold register 202 and transmit the first random number 216 to the third logic gate 212 (e.g., first back-end logic gate). Similarly, when the second guard engine 110 approves the data packet 112 for transfer to the second domain 104, the second guard engine may also transmit a release signal 222 to the hold register 202 and likewise transmit the second random number 218 to the fourth logic gate 214 (e.g., second back-end logic gate). Only when the hold register 202 receives both release signals 220, 222 is the double encrypted data packet 112b released for double decryption by the back-end logic gates 212, 214.

In embodiments, either the first guard engine 108 or the second guard engine 110 may reject the data packet 112. For example, in the event of a rejection the first guard engine 108 may withhold the release signal 220 from the hold register 202 and the random number 216 from the first back-end logic gate 212. Similarly, the second guard engine 110, upon rejecting the data packet 112, may withhold the release signal 222 from the hold register 202 and the random number 218 from the second back-end logic gate 214. In either case, the data packet 112 may be prevented from reaching the second domain 104. In some embodiments, the rejecting guard engine (108, 110) may clear the hold register 202. In the event of a rejection of the data packet 112, the rejecting guard engine (108, 110) may notify the first domain 102 and/or the second domain 104 of the rejection.

In embodiments, the back-end logic gates 212, 214 may sequentially double decrypt the double-encrypted data packet 112b for transfer to the second domain 104. For example, the hold register 202 may release the double-encrypted data packet 112b (e.g., upon receipt of both release signals 220, 222 as described above) to the third logic gate 212, which partially decrypts the data packet according to the first random number 216 (e.g., canceling out the first front-end logic gate 208). The partially decrypted data packet may then be passed to the fourth logic gate 212 for partial decryption (e.g., completion of the sequential decryption process) according to the second random number 218. The double decrypted data packet 112 may then pass to the second domain 104 as a plain text data packet. Any errant release of the data packet 112b through the back-end logic gates 212, 214 for decryption prior to the back-end logic gates being updated with the relevant random numbers 216, 218 results in an unrecoverable encrypted data packet 112a-b being passed to the second domain 104, maintaining the MILS integrity of the MILS processing environment 100.

In embodiments, implementation of sequential double decryption by the cross-domain solution 106 may enforce sequential redundant inspection of the data packet 112. For example, a failure of either the first or second guard engine 108, 110, resulting in an errant transmission or rejection of the data packet 112a-b by either or both guard engines, leaves the outgoing data packet in a single-encrypted (112a) or double-encrypted (112b) state (e.g., and unrecoverable in either state).

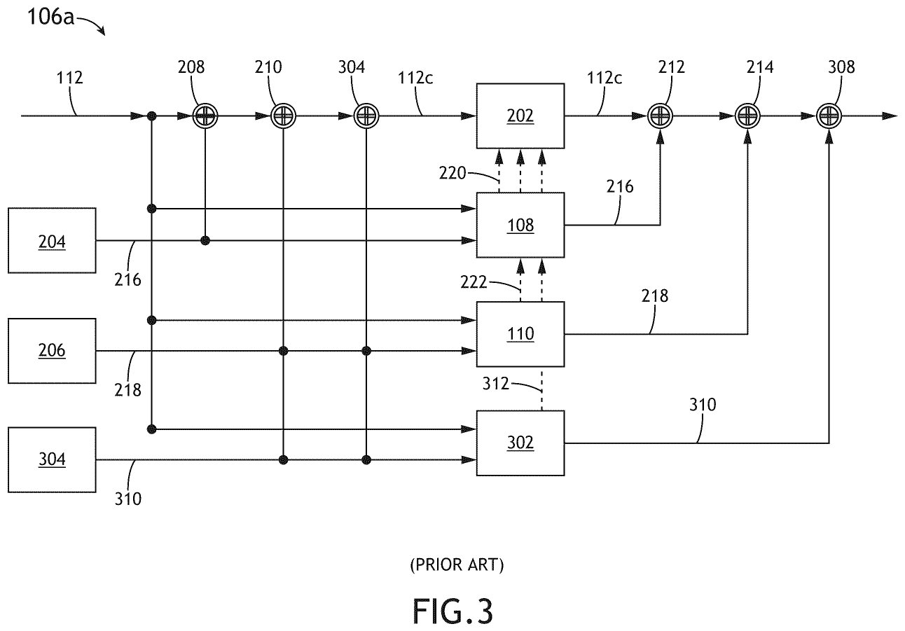

Referring to FIG. 3, the cross-domain solution 106a may be implemented and may function similarly to the cross-domain solution 106 of FIG. 2, except that the cross-domain solution 106a may be scaled up to include three parallel guard engines 108, 110, 302; three RNGs 204, 206, 304; and three front-end and back-end logic gates (e.g., front-end logic gates 208, 210, 306 and back-end logic gates 212, 214, 308). We note that a cross-domain solution similar to FIG. 3 is disclosed in U.S. Pat. No. 11,296,876, filed on Sep. 11, 2020, which is incorporated by reference in its entirety.

In embodiments, the cross-domain solution 106a may sequentially triple-encrypt the data packet 112 via front-end logic gates 208, 210, 306 according to random numbers 216, 218, 310. The triple-encrypted data packet 112c (e.g., after the third and final stage of sequential encryption by the third front-end logic gate 306) may be stored by the hold register 202 until release signals 220, 222, 312 are received from all three guard engines 108, 110, 302 indicating their inspection and approval of the data packet 112. The released triple-encrypted data packet 112c may be sequentially decrypted by the back-end logic gates 212, 214, 308 according to the random numbers 216, 218, 310 transmitted to the back-end logic gates by the guard engines 108, 110, 302 upon inspection and approval of the data packet 112.

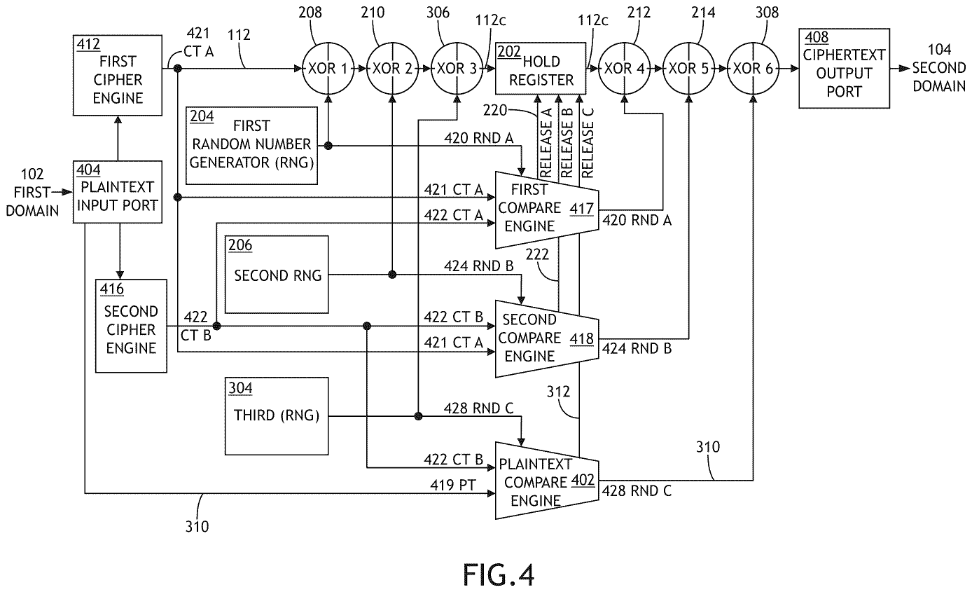

FIG. 4 illustrates a schematic of a fault tolerant cryptographic control 400 in accordance with one or more embodiments of the disclosure. Fault tolerant cryptographic control 400 may include one or more components of the cross-domain solutions 92, 92a, and vice versa. The fault tolerant cryptographic control 400 enables decrypted plain text data, such as a plaintext input (e.g., received by a plaintext input port 404) from a first domain 102 to be outputted as an encrypted ciphertext output (e.g., via a ciphertext output port 408) that can be safely received by the second domain 104. The fault tolerant cryptographic control 400 may also include components that similarly allow plaintext from the second domain 104 to be received as ciphertext by the first domain 102, as described herein.

It should be understood that if ciphertext data arrives on the plaintext side due to a fault, ciphertext is unusable, as it is still encrypted. However, data that faults from the plaintext side to the ciphertext side is of consequence, which is addressed by fault tolerant cryptographic control 400.

In embodiments, a plaintext input received from the one or more plaintext input ports 404 is routed to a first cipher engine 412, and a copy of the plaintext input is routed to a second cipher engine 416, and a third copy (PT 419) is routed to a plaintext compare engine 402. The first cipher engine 412 and second cipher engine 416 each complete an encryption on a block of data using an algorithm such as AES. For example, the first cipher engine 412 generates a first ciphertext data packet (CT-A 421) and the second cipher engine 416 generates a second ciphertext data packet (CT-B 422).

The plaintext compare engine 402, as well as first comparison engine 417 and second comparison engine 418 has some similarity to the third guard engine 302, first guard engine 108, and second guard engine 110 of cross domain solution 92a, respectively. However, the plaintext compare engine 402, the first comparison engine 417 and the second comparison engine 418 operates on plaintext, inspecting the context of the plain text to ensure the information contained within the data packet 112 inspected is safe to transmit to the other side. This is done using a set of rules established a priori. For example, the first comparison engine 417 and the second comparison engine 418 receive the outputs of the first cipher engine 412 and second cipher engine 416, and perform a bit-by-bit comparison for agreement (e.g., absolute agreement). In another example, the plaintext compare engine 402 receives the plaintext input (PT 419) and performs a compare function for disagreement. For instance, if the encryption by the second cipher engine 416 is performed, then the output from the second cipher engine 416 and the plaintext input (PT 419) should not match.

It should be understood that once the plaintext has been converted to ciphertext by the first cipher engine 412 and the second cipher engine 416 that the plaintext has been encrypted. However, the fault tolerant cryptographic control 400 further encrypts the ciphertext, and then decrypts the “encrypted” ciphertext back to a base encrypted level (e.g., not decrypted from ciphertext to plaintext) as part of the control process. For the sake of clarity, a partial or full decryption of a partially or fully encrypted ciphertext (e.g., by logic gates 208, 210, 306, 212, 214, 308) within the fault tolerant cryptographic control 400 is intended to mean that the partially or fully decrypted ciphertext is still ciphertext and not plaintext. Once the ciphertext output leaves the ciphertext output port 408, the ciphertext may be decrypted back to plaintext.

In embodiments, the first RNG 204, the second RNG 206, and the third RNGs 304 generate random numbers. These random numbers may be equivalent to the same block size as the output of the first cipher engine 412 and the second cipher engine 416 (for example 128 bits in the case of AES). The random number may be either a true random number generator, or a pseudo random number generator seeded with a random value.

In embodiments, the output of the first cipher engine 412 is first encrypted (e.g., XOR'd) by logic gate 208 with the one-time-pad output of the first RNG 204 (e.g., RND-A 420). The result of logic gate 208 is then encrypted again (e.g., double encrypted) via logic gate 210 with a one-time-pad output of the second RNG 206 (e.g., RND-B 424). The result of logic gate 210 is then encrypted again (e.g., triple encrypted) via logic gate 306 with a one-time-pad output of the third RNG 304) (e.g., RND-C 428). The output of the logic gate 306 is then placed in the hold register 202 to await release upon a successful comparison of the first compare engine 417, the second compare engine, 418, and the plaintext compare engine 402. Therefore, the block held within the hold register 202 is triple encrypted as expressed by XOR functions (e.g., with logic gates 208, 210, 306 acting as logic functions performing an encryption).

In embodiments, the first compare engine 417 receives and compares inputs CT-A 421 and CT-B 422 from the first cipher engine 412 and the second cipher engine 416, respectively. The one-time-pad RND-A 420 may be inputted to the First Compare Engine 417 for later output contingent upon a successful comparison. Once the comparison function is complete, inputs CT-A 421 and CT-B 422 at the first compare engine 417 may be erased, as there is no path for the CT-A 421 and CT-B 422 data packets to be received from the output of the first compare engine 417. Upon a successful comparison between inputs CT-A 421 and CT-B 422, the first compare engine 417 sends a release (e.g., Release A) to the hold register 202, and the one-time-pad RND-A 420 is released for use by logic gate 212.

In embodiments, the second compare engine 418 receives and compares inputs CT-A 421 and CT-B 422 from the first cipher engine 412 and the second cipher engine 416, respectively. The one-time-pad RND-B 424 may be inputted to the Second Compare Engine 418 for later output contingent upon a successful comparison. Once the comparison function is complete, inputs CT-A 421 and CT-B 422 at the second compare engine 418 may be erased, as there is no path for the CT-A 421 and CT-B 422 data packets to be received from the output of the second compare engine 418. Upon a successful comparison between inputs CT-A 421 and CT-B 422, the second compare engine 418 sends a release (e.g., Release B) to the hold register 202, and the one-time-pad RND-B 424 is released for use by logic gate 214.

In embodiments, the plaintext compare engine 402 receives the plaintext output (PT 419) and input CT-B 422 for comparison. The one-time-pad RND-C 428 is also inputted to the Plaintext Compare Engine 402 for later output contingent upon a successful comparison (e.g., no matching, or less than exact matching between the plaintext and ciphertext). Once the compare function is complete, PT 419 and input CT-B 422 may be erased, as there is no path for either the plaintext data packets to arrive at the hold register from the plaintext compare engine 402. Upon a successful comparison (e.g., non-matching) between PT 419 and input CT-B 422, the plaintext compare engine 402 sends a release (Release C) to the hold register 202, and the one-time-pad is released to logic gate 308 (e.g., with logic gates 212, 214, 308 acting as logic functions performing an decryption).

Upon successful comparisons of all compare functions, the contents of the hold register 202 is released to logic gates 212, 214, 308. This later set of logic gates removes the RND one-time-pads, thereby decrypting the data packet 112c leaving it in its natively encrypted form (e.g., as input CT-A 421 from the first cipher engine 412). For example, the logic gate 212 may partially decrypt the third-encrypted ciphertext data packet according to the first one-time pad RND-A 420. In another example, the logic gate 214 may partially decrypt the second-encrypted ciphertext data packet according to the second one-time pad RND-B 424. In another example, the logic gate 308 may fully decrypt (e.g., to the native ciphertext input CT-A 421) the third-encrypted ciphertext data packet according to the third one-time pad RND-C 428.

In embodiments, parallel or redundant components within the fault tolerant cryptographic control 400 are procured from different sources. For example, the first cipher engine 412 may be sourced from a different company or manufacturer than the second cipher engine 416 (e.g., running the same algorithm). Similarly, the random number generators 204, 206, 304, and compare engines 402, 417, 418, may be differently sourced. Building the fault tolerant cryptographic control 400 from different sources reduces the possibility of a common mode failure.

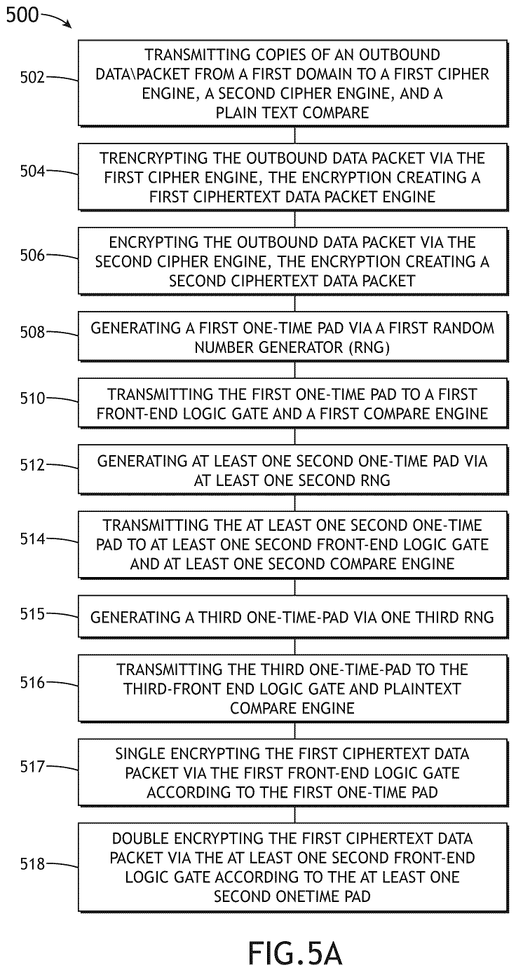

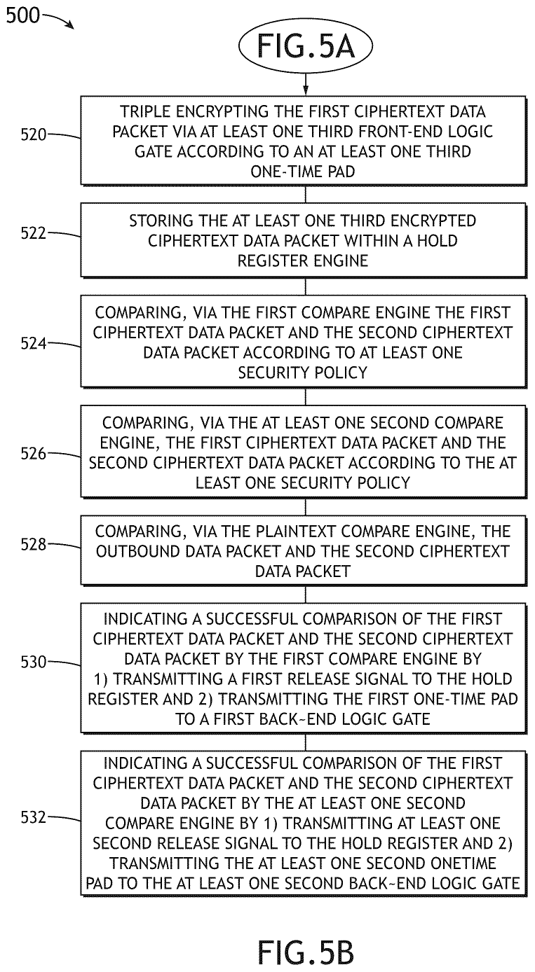

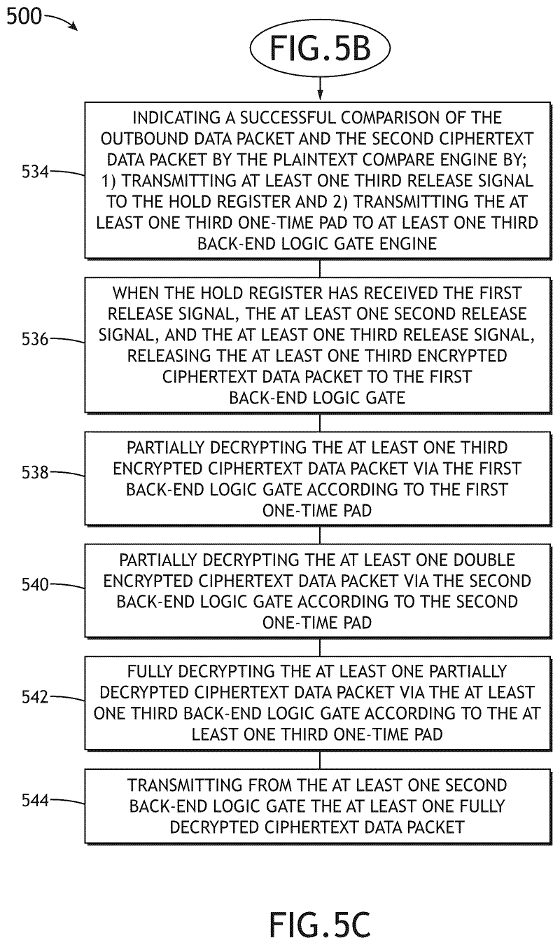

FIGS. 5A through 5C are flow diagrams illustrating a method 500 for comparison with fault tolerant cryptographic control, according to example embodiments of this disclosure. The method 500 may be utilized by the fault tolerant cryptographic control 400as described herein.

In embodiments, the method 500 includes a step 502 of transmitting copies of an outbound data packet from a first domain 102 to a first cipher engine 412, a second cipher engine 416, and a plaintext compare engine 402. The original outbound data packet may also be sent to the first cipher engine 412, the second cipher engine 416, and/or the plaintext compare engine 402.

In embodiments, the method 500 includes a step 504 of encrypting the outbound data packet via the first cipher engine 412, the encryption creating a first ciphertext data packet (input CT-A 412).

In embodiments, the method 500 includes a step 506 of encrypting the outbound data packet via the second cipher engine 416, the encryption creating a second ciphertext data packet (input CT-B 422).

In embodiments, the method 500 includes a step 508 of generating a first one-time pad (RND-A 420) via a first random number generator (RNG 204).

In embodiments, the method 500 includes a step 510 of transmitting the first one-time pad (RND-A 420) to a first front-end logic gate 208 and a first compare engine 417.

In embodiments, the method 500 includes a step 512 of generating at least one second one-time pad (RND-B 424) via at least one second RNG 206.

In embodiments, the method 500 includes a step 514 of transmitting the at least one second one-time pad (RND-B 424) to at least one second front-end logic gate 210 and at least one second compare engine 418.

In embodiments, the method 500 includes a step 515 of generating a third one-time-pad (RND-C 422) via a third RNG 304.

In embodiments, the method 500 includes a step 516 of transmitting the third one-time-pad (RND-C 422) to the third-front end logic gate 306 and plaintext compare engine 402.

In embodiments, the method 500 includes a step 517 of single encrypting the first ciphertext data packet (CT-A 421) via the first front-end logic gate 208 according to the first one-time pad (RND-A 420).

In embodiments, the method 500 includes a step 518 of double encrypting the first ciphertext data packet (CT-A 421) via the at least one second front-end logic gate 210 according to the at least one second one-time pad (RND-B 424).

In embodiments, the method 500 includes a step 520 of triple encrypting the first ciphertext data packet (CT-A 421) via at least one third front-end logic gate 306 according to an at least one third one-time pad (RND-C 428).

In embodiments, the method 500 includes a step 522 of storing the at least one third encrypted ciphertext data packet (CT-A 421) within a hold register.

In embodiments, the method 500 includes a step 524 of comparing, via the first compare engine 417 the first ciphertext data packet (CT-A 421) and the second ciphertext data packet (CT-B 422) according to at least one security policy (e.g., a set of rules established a priori).

In embodiments, the method 500 includes a step 526 of comparing, via the at least one second compare engine 418, the first ciphertext data packet (CT-A 421) and the second ciphertext data packet (CT-B 422) according to the at least one security policy (e.g., a set of rules established a priori).

In embodiments, the method 500 includes a step 528 of comparing, via the plaintext compare engine 402, the outbound data packet (PT 419) and the second ciphertext data packet (CT-B 422). For example, the first ciphertext data packet (CT-A 421) and the second ciphertext data packet (CT-B 422) may be compared according to the at least one security policy (e.g., a set of rules established a priori).

In embodiments, the method 500 includes a step 530 of indicating a successful comparison of the first ciphertext data packet (CT-A 421) and the second ciphertext data packet (CT-B 422) by the first compare engine 417 by 1) transmitting a first release signal to the hold register 202 and 2) transmitting the first one-time pad (RND-A 420) to a first back-end logic gate 212.

In embodiments, the method 500 includes a step 532 of indicating a successful comparison of the first ciphertext data packet (CT-A 421) and the second ciphertext data packet (CT-B 422) by the at least one second compare engine 418 by 1) transmitting at least one second release signal to the hold register 202 and 2) transmitting the at least one second one-time pad (RND-B 424) to the at least one second back-end logic gate 214.

In embodiments, the method 500 includes a step 534 of indicating a successful comparison of the outbound data packet (PT 419) and the second ciphertext data packet (CT-B 422) by the plaintext compare engine 402 by; 1) transmitting at least one third release signal to the hold register 202 and 2) transmitting the at least one third one-time pad (RND-C 428) to at least one third back-end logic gate 308. For example, a successful comparison of the plaintext input data packet PT 419 to the second ciphertext data packet CT-B 422 (e.g., where the comparison evaluates as TRUE) may be an determination that the plaintext input data packet PT 419 and the second ciphertext data packet CT-B 422 are NOT EQUAL.

In embodiments, the method 500 includes a step 536 of, when the hold register 202 has received the first release signal, the at least one second release signal, and the at least one third release signal, releasing the at least one third encrypted ciphertext data packet (CT-A 421) to the first back-end logic gate 212.

In embodiments, the method 500 includes a step 538 of partially decrypting the at least one third encrypted ciphertext data packet (CT-A 421) via the first back-end logic gate 212 according to the first one-time pad (RND-A 420).

In embodiments, the method 500 includes a step 540 of partially decrypting the at least one double encrypted ciphertext data packet (CT-A 421) via the second back-end logic gate 214 according to the second one-time pad (RND-B 424).

In embodiments, the method 500 includes a step 542 of fully decrypting the at least one partially decrypted ciphertext data packet (CT-A 421) (e.g., to the native ciphertext data packet encrypted by the first cipher engine 412) via the at least one third back-end logic gate 308 according to the at least one third one-time pad (RND-C 428).

In embodiments, the method 500 includes a step 544 of transmitting, from the at least one second back-end logic gate 308, the at least one fully decrypted ciphertext data packet (e.g., to a second domain 104 via the ciphertext output port 408.

Due to the redundant nature of the fault tolerant cryptographic control 400, no single fault or dual fault in the data path can leak information because the data is encrypted by the logic gates 208, 210, 306. No single fault or dual fault in the comparator path can leak data because the ciphertext and plaintext data has no path to the output of the compare function, as only the random number being held in the register of the comparison function can exit the compare function. Table 1 lists the single faults that can occur within the fault tolerant cryptographic control 400 and how the fault tolerant cryptographic control 400 prevents plaintext from leaking (e.g., to the ciphertext output port 408) after the fault has occurred. Table 2 lists the dual faults that can occur within the fault tolerant cryptographic control 400 and how the fault tolerant cryptographic control 400 prevents plaintext from leaking (e.g., to the ciphertext output port 408) after the dual faults have occurred.

TABLE 1

| Faulted Item | Issue | Consequence |
|---|---|---|
| First Cipher | Fails to encrypt | First compare engine 417 and Second compare |
| Engine 412 | | engine 418 halt operation, RND-A and RND-B not |
| | | released to logic gates, leaving ciphertext in hold |
| | | register 202 double encrypted |
| Second Cipher | Fails to encrypt | First compare engine 417 and Second compare |
| Engine 416 | | engine 418 halt operation, RND-A and RND-B not |
| | | released to logic gates, leaving ciphertext in hold |
| | | register 202 double encrypted |
| First RNG 204 | Poor quality random | Plaintext is correctly encrypted, and ciphertext is |
| | number | output |
| Second RNG 206 | Poor random number | Plaintext is correctly encrypted, and ciphertext is |
| | | output |
| First Compare | Mis-comparison of CT-A | Hold Register 202 is not released; RND-A not released |
| Engine 417 | with CT-B or functional | to logic gate 212 leaving ciphertext in hold register |
| | failure | 202 double encrypted |
| Second Compare | Mis-comparison of CT B | Hold Register 202 is not released; RND-B is not |
| Engine 418 | with CT A or functional | released back into |
| | failure | |
| Hold Register | Releases early | Contents remain encrypted by RND A and RND B |
| 202 | (premature release) | |
| Any logic gate | Fails to function (XOR) | Contents remain encrypted by RND A or RND B |

TABLE 2

| Faulted Items | Issue | Consequence |
|---|---|---|
| First Cipher Engine | Fail to encrypt | Plaintext Compare Engine 402 halts operation, RND- |
| 412 and Second | | C not released to logic gate 308, leaving ciphertext in |
| Cipher Engine 416 | | hold register 202 encrypted by RNDs |
| All RNGs 204, 206, | Poor quality | Plaintext is correctly encrypted, and Ciphertext is |
| 304 | random | correctly output |
| | number | |
| All Compare Engines | Mis- | Hold Register 202 is not released, RNDs not released |
| 417, 418, 402 | comparison | to logic gates, leaving ciphertext in hold register |
| | or functional | encrypted by RNDs |
| | failure | |
| (First Cipher Engine | Fails to | The unfaulted pair halts operation, with associated |
| 412 or Second | encrypt and | RNDs not released to respective logic gates, leaving |
| Cipher Engine 416) | mis-compares | ciphertext in hold register 202 encrypted by RNDs |
| and (First Compare | as valid | |
| Engine 417 or | | |
| Second Compare | | |
| Engine 418) | | |
| Any to all logic gates | Fails to XOR | Plaintext is correctly encrypted and ciphertext is |
| | | correctly output with carrying levels of encryption by |
| | | one or more RNDs |

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

I claim:

1. A fault tolerant cryptographic control system, comprising:
a first cipher engine, a second cipher engine, and a plaintext compare engine, wherein the first cipher engine, the second cipher engine, and the plaintext compare engine are configured to receive copies of an outbound data packet, wherein the first cipher engine and the second cipher engine are configured to encrypt the outbound data packet via at least one security policy, generating a first ciphertext data packet and a second ciphertext data packet;
a first random number generator (RNG) configured to generate a first one-time pad;
a second RNG configured to generate at least one second one-time pad;
a third RNG configured to generate a third one-time pad;
a first front-end logic gate configured to encrypt the first ciphertext data packet according to the first one-time pad;
a second front-end logic gate configured to double encrypt the first ciphertext data packet according to the at least one second one-time pad;
a third front-end logic gate configured to triple encrypt the first ciphertext data packet according to an at least one third one-time pad; and
a hold register configured to store at least one third encrypted ciphertext data packet.

2. The fault tolerant cryptographic control system of claim 1, wherein the first ciphertext data packet and the second ciphertext data packet are inspected via a first compare engine according to the at least one security policy, wherein the first ciphertext data packet and the second ciphertext data packet are inspected via an second compare engine according to the at least one security policy, wherein the outbound data packet and the second ciphertext data packet are inspected by the plaintext compare engine, wherein a successful comparison of the first ciphertext data packet and the second ciphertext data packet by the first compare engine is indicated by 1) transmitting a first release signal to the hold register and 2) transmitting the first one-time pad to a first back-end logic gate, wherein successful comparison of the first ciphertext data packet and the second ciphertext data packet by the second compare engine is indicated by 1) transmitting at least one second release signal to the hold register and 2) transmitting the at least one second one-time pad to a second back-end logic gate, wherein a successful comparison of the outbound data packet and the second ciphertext data packet by the plaintext compare engine is indicated by; 1) transmitting at least one third release signal to the hold register and 2) transmitting the at least one third one-time pad to at least one third back-end logic gate, wherein the hold register is configured to release the at least one third encrypted ciphertext data packet to the first back-end logic gate when the hold register has received the first release signal, the at least one second release signal, and the at least one third release signal.

3. The fault tolerant cryptographic control system of claim 2, further comprising:
the first back-end logic gate, wherein the first back-end logic gate is configured to partially decrypt the at least one third encrypted ciphertext data packet according to the first one-time pad;
the second back-end logic gate, wherein the second back-end logic gate is configured to partially decrypt the double encrypted ciphertext data packet according to the at least one second one-time pad; and
the third back-end logic gate, wherein the third back-end logic gate is configured to fully decrypt the partially decrypted ciphertext data packet according to the third one-time pad.

4. The fault tolerant cryptographic control system of claim 3, wherein the first front-end logic gate, the at least one second front-end logic gate, the first back-end logic gate, and the at least one second back-end logic gate include at least one bitwise exclusive-or (XOR) logic gate.

5. The fault tolerant cryptographic control system of claim 3, wherein a fault of the first cipher engine prevents the first cipher engine from generating a first ciphertext data packet, wherein preventing the first cipher engine from generating a first ciphertext data packet causes the first compare engine and the second compare engine to halt operation and prevents the first ciphertext data packet from being released from the hold register.

6. The fault tolerant cryptographic control system of claim 3, wherein a fault of the first cipher engine prevents the second cipher engine from generating a second ciphertext data packet, wherein preventing the second cipher engine from generating a second ciphertext data packet causes the first compare engine and the second compare engine to halt operation and prevents the first ciphertext data packet from being released from the hold register.

7. The fault tolerant cryptographic control system of claim 3, wherein a fault one or more RNGs causes a generation of poor quality random numbers, wherein the generation of poor quality random numbers does not prevent encryption of the generating a first ciphertext data packet by the first cipher engine, and does not prevent the first ciphertext data packet from being received by a ciphertext output port.

8. The fault tolerant cryptographic control system of claim 3, wherein a fault in the first compare engine causes a mis-comparison between the first ciphertext data packet and the second first ciphertext data packet, wherein a mis-comparison between the first ciphertext data packet and the second first ciphertext data packet prevents the first ciphertext data packet from being released from the hold register.

9. The fault tolerant cryptographic control system of claim 3, wherein a fault in the second compare engine causes a mis-comparison between the first ciphertext data packet and the second first ciphertext data packet, wherein a mis-comparison between the first ciphertext data packet and the second first ciphertext data packet prevents the first ciphertext data packet from being released from the hold register.

10. The fault tolerant cryptographic control system of claim 3, wherein a fault in the hold register causes a premature release of first ciphertext data packet, wherein a premature release of the first ciphertext data packet causes first ciphertext data packets received by a ciphertext output port that are encrypted by the first cipher engine.

11. The fault tolerant cryptographic control system of claim 3, wherein a fault in one or more logic gates causes the first ciphertext data packets received by a ciphertext output port that are encrypted by the first cipher engine.

12. The fault tolerant cryptographic control system of claim 3, wherein a failure of both the first cipher engine and the second cipher engine causes the plaintext compare engine to halt operation, causing the plaintext compare engine to halt operation prevents the first ciphertext data packet from being released from the hold register.

13. The fault tolerant cryptographic control system of claim 3, wherein upon a failure of at least two of the first compare engine, the second compare engine, and the plaintext compare engine prevents the first ciphertext data packet from being released from the hold register.

14. The fault tolerant cryptographic control system of claim 3, wherein a fault of 1) the first cipher engine or the second cipher engine and 2) one or more of the first compare engine, the second compare engine, and the plaintext compare engine prevents the first ciphertext data packet from being released from the hold register.

15. A method for cross-domain comparison with fault tolerant cryptographic control comprising:
transmitting copies of an outbound data packet from a first domain to a first cipher engine, a second cipher engine, and a plaintext compare engine;
encrypting the outbound data packet via the first cipher engine, the encryption creating a first ciphertext data packet;
encrypting the outbound data packet via the second cipher engine, the encryption creating a second ciphertext data packet;
generating a first one-time pad via a first random number generator (RNG);
transmitting the first one-time pad to a first front-end logic gate and a first compare engine;
generating at least one second one-time pad via at least one second RNG;
transmitting the at least one second one-time pad to at least one second front-end logic gate and at least one second compare engine;
generating a third one-time-pad via one third RNG;
transmitting the third one-time-pad to a third-front end logic gate and plaintext compare engine;
single encrypting the first ciphertext data packet via the first front-end logic gate according to the first one-time pad;
double encrypting the first ciphertext data packet via the at least one second front-end logic gate according to the at least one second one-time pad;
triple encrypting the first ciphertext data packet via at least one third front-end logic gate according to an at least one third one-time pad;
storing the at least one third encrypted ciphertext data packet within a hold register;
comparing, via the first compare engine the first ciphertext data packet and the second ciphertext data packet according to at least one security policy;
comparing, via the at least one second compare engine, the first ciphertext data packet and the second ciphertext data packet according to the at least one security policy;
comparing, via the plaintext compare engine, the outbound data packet and the second ciphertext data packet;
indicating a successful comparison of the first ciphertext data packet and the second ciphertext data packet by the first compare engine by 1) transmitting a first release signal to the hold register and 2) transmitting the first one-time pad to a first back-end logic gate;
indicating a successful comparison of the first ciphertext data packet and the second ciphertext data packet by the at least one second compare engine by 1) transmitting at least one second release signal to the hold register and 2) transmitting the at least one second one-time pad to the at least one second back-end logic gate;
indicating a successful comparison of the outbound data packet and the second ciphertext data packet by the plaintext compare engine by; 1) transmitting at least one third release signal to the hold register and 2) transmitting the at least one third one-time pad to at least one third back-end logic gate;
when the hold register has received the first release signal, the at least one second release signal, and the at least one third release signal, releasing the at least one third encrypted ciphertext data packet to the first back-end logic gate;
partially decrypting the at least one third encrypted ciphertext data packet via the first back-end logic gate according to the first one-time pad;
partially decrypting the at least one double encrypted ciphertext data packet via the second back-end logic gate according to the second one-time pad;
fully decrypting the at least one partially decrypted ciphertext data packet via the at least one third back-end logic gate according to the at least one third one-time pad; and
transmitting from the at least one third back-end logic gate the at least one fully decrypted ciphertext data packet.

16. The method of claim 15, wherein the first front-end logic gate, the at least one second front-end logic gate, the first back-end logic gate, and the at least one second back-end logic gate include at least one bitwise exclusive-or (XOR) logic gate.

17. The method of claim 15, wherein a fault of the first cipher engine prevents the first cipher engine from generating a first ciphertext data packet, wherein preventing the first cipher engine from generating a first ciphertext data packet causes the first compare engine and the second compare engine to halt operation and prevents the first ciphertext data packet from being released from the hold register.

18. The method of claim 15, wherein a fault of the first cipher engine prevents the second cipher engine from generating a second ciphertext data packet, wherein preventing the second cipher engine from generating a second ciphertext data packet causes the first compare engine and the second compare engine to halt operation and prevents the first ciphertext data packet from being released from the hold register.

19. The method of claim 16, wherein a fault in the first compare engine causes a mis-comparison between the first ciphertext data packet and the second first ciphertext data packet, wherein a mis-comparison between the first ciphertext data packet and the second first ciphertext data packet prevents the first ciphertext data packet from being released from the hold register.

20. The method of claim 16, wherein a successful comparison of a plaintext input data packet to the second ciphertext data packet is a determination that the plaintext input data packet and the second ciphertext data packet are not equal.
